(19) United States
(12) Patent Application Publication
(10) Pub. No.: US 2022/0141476 A1
(43) Pub. Date: May 5, 2022

(54) Lightweight Transcoding at Edge Nodes

(71) Applicant: BITMOVIN, INC., San Francisco, CA (US)

(72) Inventors: Alireza Erfanian, Klagenfurt am Worthersee (AT); Hadi Amirpour, Klagenfurt am Worthersee (AT); Christian Timmerer, Klagenfurt am Worthersee (AT); Hermann Hellwagner, Klagenfurt am Worthersee (AT)

(73) Assignee: BITMOVIN, INC., San Francisco, CA (US)

(21) Appl. No.: 17/390,070

(22) Filed: Jul. 30, 2021

Related U.S. Application Data
(60) Provisional application No. 63/108,244, filed on Oct. 30, 2020.

(51) Int. Cl. H04N 19/40

(52) U.S. Cl. CPC H04N 19/40

(57) ABSTRACT

Disclosed are systems and methods for lightweight transcoding of video. A distributed computing system for lightweight transcoding includes an origin server and an edge node, the origin server having a memory and a processor and configured to receive an input video comprising a bitstream, encode the bitstream into a set of representations corresponding to a full bitrate ladder, generate encoding metadata for the set of representations, and provide a representation and encoding metadata for the set of representations to an edge node, the edge node having a memory and a processor and configured to transcode the bitstream, or segments thereof, into the set of representations, and to serve one or more of the representations to a client.

### CROSS-REFERENCE TO RELATED APPLICATIONS

This application claims the benefit of U.S. Provisional Patent Application No. 63/108,244, filed Oct. 30, 2020, and titled “Lightweight Transcoding on Edge Servers,” which is incorporated herein by reference in its entirety.

### BACKGROUND OF INVENTION

There is a growing demand for video streaming services and content. Video streaming providers are facing difficulties meeting this growing demand with increasing resource requirements for increasingly heterogeneous environments. For example, in HTTP Adaptive Streaming (HAS) the server maintains multiple versions (i.e., representations in MPEG DASH) of the same content split into segments of a given duration (i.e., 1-10 s) which can be individually requested by clients using a manifest (i.e., MPD in MPEG DASH) and based on its context conditions (e.g., network capabilities/conditions and client characteristics). Consequently, a content delivery network (CDN) is responsible for distributing all segments (or subsets thereof) within the network towards the clients. Typically, this results in a large amount of data being distributed within the network (i.e., from the source towards the clients).

Conventional approaches to mitigating the problem focus on caching efficiency, on-the-fly transcoding, and other solutions that typically require trade-offs among various cost parameters, such as storage, computation and bandwidth. On-the-fly transcoding approaches are computationally intensive and time-consuming, imposing significant operational costs on service providers. On the other hand, pre-transcoding approaches typically store all bitrates to meet all user types of user requests, which incurs high storage overhead, even for videos and video segments that are rarely requested.

Thus, a solution for lightweight transcoding of video at edge nodes is desirable.

### BRIEF SUMMARY

The present disclosure provides for techniques relating to lightweight transcoding of video at edge nodes. A distributed computing system for lightweight transcoding may include: an origin server having a first memory, and a first processor configured to execute instructions stored in the first memory to: receive an input video comprising a bitstream, encode the bitstream into n representations, and generate encoding metadata for n−1 representations; and an edge node having a second memory, and a second processor configured to execute instructions stored in the second memory to: fetch a representation of the n representations and the encoding metadata from the origin server, transcode the bitstream, and serve one of the n representations to a client. In some examples, the n representations correspond to a full bitrate ladder. In some examples, the first processor is further configured to execute instructions stored in the first memory to compress the encoding metadata. In some examples, the encoding metadata comprises a partitioning structure of a coding tree unit. In some examples, the encoding metadata results from an encoding of the bitstream. In some examples, the representation corresponds to a highest bitrate, and the encoding metadata corresponds to other bitrates. In some examples, the second processor is configured to transcode the bitstream using a transcoding system. In some examples, the transcoding system comprises a decoding module and an encoding module.

A method for lightweight transcoding may include: receiving, by a server, an input video comprising a bitstream; encoding, by the server, the bitstream into n representations; generating metadata for n−1 representations; and providing to an edge node a representation of the n representations and the metadata, wherein the edge node is configured to transcode the bitstream into the n−1 representations using the metadata. In some examples, the n representations correspond to a full bitrate ladder. In some examples, the representation comprises a highest quality representation corresponding to a highest bitrate. In some examples, the representation comprises an intermediate quality representation corresponding to an intermediate bitrate. In some examples, generating the metadata comprises storing an optimal search result from the encoding as part of the metadata. In some examples, generating the metadata comprises storing an optimal decision from the encoding as part of the metadata. In some examples, the method also may include compressing the metadata. In some examples, the representation comprises a subset of the n representations.

A method for lightweight transcoding may include: fetching, by an edge node from an origin server, a representation of a video segment and metadata associated with a plurality of representations of the video segment, the origin server configured to encode a bitstream into the plurality of representations and to generate the metadata; transcoding the bitstream into the plurality of representations using the representation and the metadata; and serving one or more of the plurality of representations to a client in response to a client request. In some examples, the method also may include determining, according to an optimization model, whether the representation of the video segment should comprise one of the plurality of representations or all of the plurality of representations. In some examples, the optimization model comprises an optimal boundary point between a first set of segments for which one of the plurality of representations should be fetched and a second set of segments for which all of the plurality of representations should be fetched, the determining based on whether the video segment is in the first set of segments or the second set of segments. In some examples, the method also may include determining the optimal boundary point using a heuristic algorithm.

### BRIEF DESCRIPTION OF THE DRAWINGS

Various non-limiting and non-exhaustive aspects and features of the present disclosure are described hereinbelow with references to the drawings, wherein:

FIGS. 1A-1B are simplified block diagrams of an exemplary lightweight transcoding systems, in accordance with one or more embodiments.

FIG. 2 is a diagram of an exemplary coding tree unit partitioning structure, in accordance with one or more embodiments.

FIGS. 3A-3C are diagrams of exemplary video streaming networks and placement of transcoding nodes therein, in accordance with one or more embodiments.

FIG. 4 is a flow diagram illustrating a method for lightweight transcoding at edge nodes, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for lightweight transcoding on edge nodes.

The invention is directed to a lightweight transcoding system and methods of lightweight transcoding at edge nodes. In order to serve the demands of heterogeneous environments and mitigate network bandwidth fluctuations, it is important to provide streaming services (e.g., video-on-demand (VoD)) with different quality levels. In video delivery (e.g., using HTTP Adaptive Streaming (HAS)), a video source may be divided into parts or intervals known as video segments. Each segment may be encoded at various bitrates resulting in a set of representations (i.e., a representation for each bitrate). Storing optimal search results and decisions of an encoding performed by an origin server, and saving such optimal results and decisions as metadata to be used in on-the-fly transcoding, allow for edge nodes (e.g., servers, interfaces, or any other resource between an origin server and a client) to be leveraged in order to reduce the amount of data to be distributed within the network (i.e., from the source towards the clients). There is no additional computation cost to extracting the metadata because the metadata is extracted during the encoding process in an origin server (i.e., part of a multi-bitrate video preparation that the origin server would perform in any encoding process). Edge nodes as used herein may refer to any edge device with sufficient compute capacity (e.g., multi-access edge computing (MEC)).

During encoding of video segments at origin servers, computationally intensive search processes are employed. Optimal results of said search processes may be stored as metadata for each video bitrate. In some examples, only the highest bitrate representation is kept, and all other bitrates in a set of representations are replaced with corresponding metadata (e.g., for unpopular videos). The generated metadata is very small (i.e., a small amount of data) compared to its corresponding encoded video segment. This results in a significant reduction in bandwidth and storage consumption, and decreased time for on-the-fly transcoding (i.e., at an edge node) of requested segments of videos using said corresponding metadata, rather than unnecessary search processes (i.e., at the edge node).

Example Systems

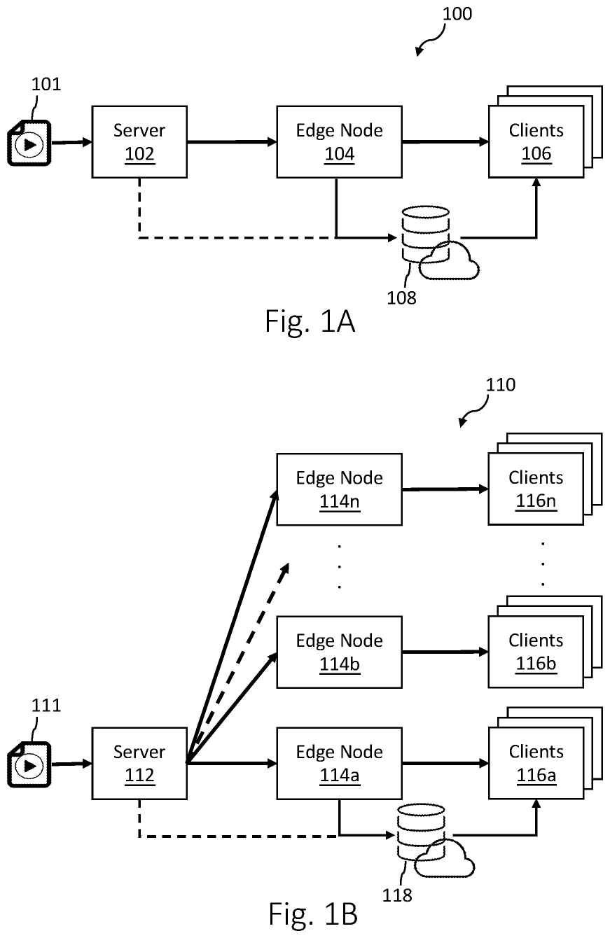

FIGS. 1A-1B are simplified block diagrams of an exemplary lightweight transcoding server network, in accordance with one or more embodiments. Network 100 includes a server 102, an edge node 104, and clients 106. Network 110 includes a server 112, a plurality of edge nodes 114a-n, and a plurality of clients 106a-n. Servers 102 and 112 (i.e., origin servers) are configured to receive video data 101 and 111, respectively, which may comprise a bitstream (i.e., input bitstream). Each of networks 100 and 110 may comprise a content delivery network (CDN). For a received bitstream, servers 102 and 112 are configured to encode a full bitrate ladder (i.e., comprising n representations) and generate encoding metadata for all representations. In some examples, servers 102 and 112 also may be configured to encode (i.e., compress) the metadata. Servers 102 and 112 may be configured to provide one representation (e.g., a highest quality (i.e., highest bitrate) representation) of the n representations to edge nodes 104 and 114a-n, respectively, along with encoding metadata for a respective bitstream. In some examples, the one representation and metadata may be fetched from servers 102 and 112 by edge nodes 104 and 114a-n. Edge nodes 104 and 114a-n (i.e., content delivery network servers) may be configured to transcode the one representation into the full bitrate ladder (i.e., the n representations) using the encoding metadata. In some examples, edge node 104 may receive a client request from one or more of clients 106, and edge nodes 114a-n may receive a plurality of client requests from one or more of clients 116a-n, respectively.

Each of servers 102 and 112 and edge nodes 104 and 114a-n may comprise at least a memory or other storage (not shown) configured to store video data, encoded data, metadata, and other data and instructions (e.g., in a database, an application, data store, or other format) for performing any of the features and steps described herein. Each of servers 102 and 112 and edge nodes 104 and 114a-n also may comprise a processor configured to execute instructions stored in a memory to carry out steps described herein. A memory may include any non-transitory computer-readable storage medium for storing data and/or software that is executable by a processor, and/or any other medium which may be used to store information that may be accessed by a processor to control the operation of a computing device (e.g., servers 102 and 112, edge nodes 104 and 114a-n, clients 106 and 116a-n). In other examples, servers 102 and 112 and edge nodes 104 and 114a-n may comprise, or be configured to access, data and instructions stored in other storage devices (e.g., storage 108 and 118). In some examples, storage 108 and 118 may comprise cloud storage, or otherwise be accessible through a network, configured to deliver media content (e.g., one or more of the n representations) to clients 106 and 116a-n, respectively. In other examples, edge node 104 and/or edge nodes 114a-n may be configured to deliver said media content to clients 106 and/or clients 116a-n directly or through other networks.

In some examples, one or more of servers 102 and 112 and edge nodes 104 and 114a-n may comprise an encoding-transcoding system, including hardware and software. The encoding-transcoding system may comprise a decoding module and an encoding module, the decoding module configured to decode an input video (i.e., video segment) from a format into a set of video data frames, the encoding module configured to encode video data frames into a video based on a video format. The encoding-transcoding system also may analyze an output video to extract encoding statistics, determine optimized encoding parameters for encoding a set of video data frames into an output video based on extracted encoding statistics, decode intermediate video into another set of video data frames, and encode the other set of video data frames into an output video based on the desired format and optimized encoding parameters. In some examples, the encoding-transcoding system may be a cloud-based encoding system available via computer networks, such as the Internet, a virtual private network, or the like. The encoding-transcoding system and any of its components may be hosted by a third party or kept within the premises of an encoding enterprise, such as a publisher, video streaming service (e.g., video-on-demand (VoD)), or the like. The system may be a distributed system, and it may also be implemented in a single server system, multi-core server system, virtual server system, multi-blade system, data center, or the like.

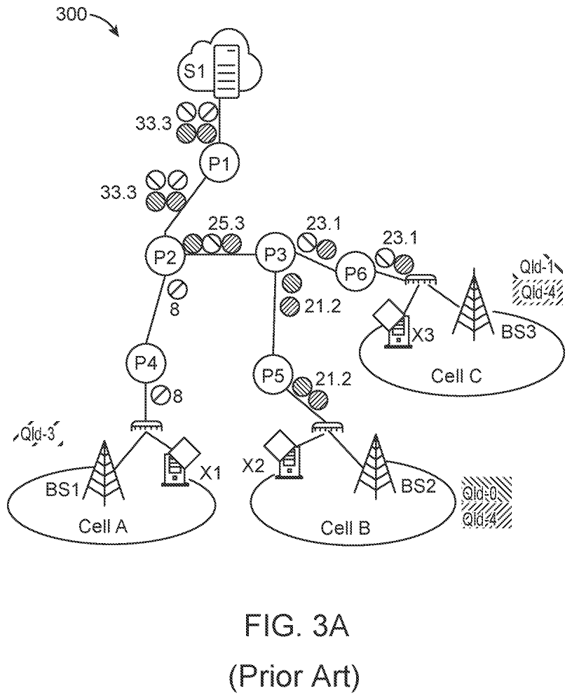

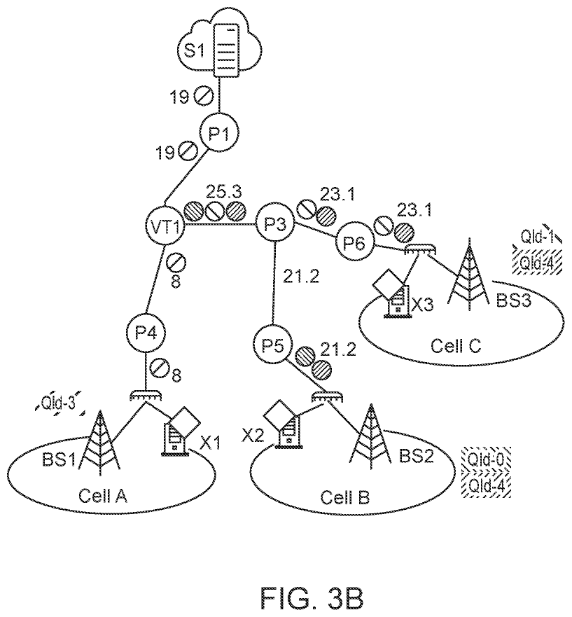

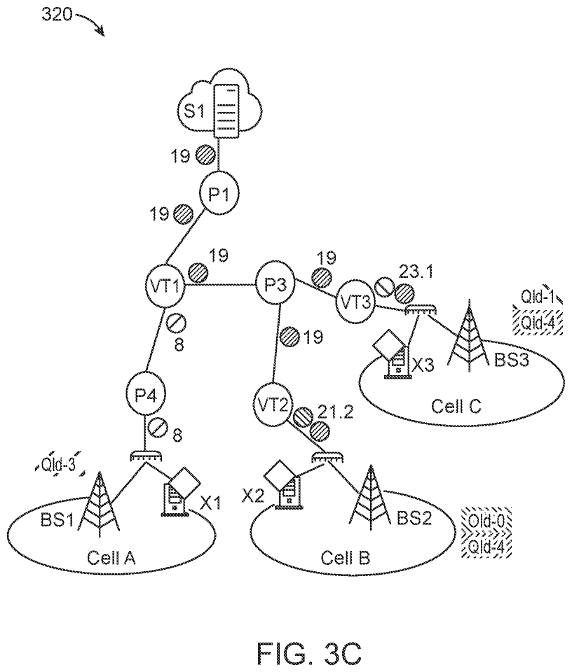

In some examples, outputs (e.g., representations, metadata, other video content data) from edge nodes 104 and 114a-n may be stored in storage 108 and 118, respectively. Storage 108 and 118 may make encoded content (e.g., the outputs) available via a network, such as the Internet. Delivery may include publication or release for streaming or download. In some examples, multiple unicast connections may be used to stream video (e.g., real-time) to a plurality of clients (e.g., clients 106 and 116a-n). In other examples, multicast-ABR may be used to deliver one or more requested qualities (i.e., per client requests) through multicast trees. In still other examples, only the highest requested quality representation is sent to an edge node, such as a virtual transcoding function (VTF) node (e.g., in context of a software defined network (SDN) and/or network function virtualization (NFV)), via a multicast tree as shown in FIGS. 3A-3C. The sent representation may be transcoded into other requested qualities in the VTF node.

In FIGS. 3A-3C, exemplary video streaming networks and placement of transcoding nodes therein are shown. In this example, VTF nodes may be placed closer to the edges for bandwidth savings. Prior art network 300 shown in FIG. 3A includes point of presence (PoP) nodes P1-P6, server 51, and cells A-C each comprising an edge server X1-X3 and base station BS1-BS3, respectively. In this example, base stations BS1-BS3 are shown as cell towers, for example, serving mobile devices. In other examples, base stations BS1-BS3 may comprise other types of wireless hubs with radio wave receiving and transmitting capabilities. In this prior art example, additional bandwidth is required to serve the requests from Cells A-C for quality levels corresponding to QId0 through QId4 when there is no transcoding capability downstream, and thus server 51 provides four representations corresponding to QId1 through QId4 to node P1 (i.e., consuming approximately 33.3 Mbps bandwidth), the same is provided from node P1 to node P2 (i.e., consuming approximately 33.3 Mbps), and so on, until Cell A receives the representation corresponding to QId3 per its request, Cell B receives representations corresponding to QId0 and QId4 per its request(s), and Cell C receives representations corresponding to QId1 and QId4 per its request(s). In an example, prior art network 300 can consume a total of approximately 195-200 Mbps.

In an example of the present invention, in network 310 shown in FIG. 3B, node P2 is replaced with a virtual transcoder (i.e., VTF) node VT1. Server 51 may provide one representation (i.e., corresponding to one quality, such as QId3 as shown) along with encoding metadata corresponding to the other qualities (e.g., QId0, QId2, and QId4) to node P1, the same being provided to node P2 (i.e., consuming approximately 19 Mbps), thereby reducing the bandwidth consumption significantly—in an example, network 310 may consume approximately 168 Mbps or less.

In another example of the present invention, in network 320 shown in FIG. 3C, nodes P5-P6 at the edge are replaced with virtual transcoder (i.e., VTF) nodes VT2-VT3, respectively. In this example, in addition to server S2 providing only one representation with encoding metadata to node P1, the same being provided to node P2, further bandwidth savings results from the placement of nodes VT2-VT3 because only one representation is also provided to node P3, as well as to nodes VT2-VT3, along with metadata for transcoding any other representations corresponding to any other qualities requested from Cells B and C. This results in additional bandwidth consumption savings—in an example, network 320 may consume approximately 155 Mbps or less. FIGS. 3A-3C are exemplary, and similar networks can implement VTF nodes at the edge of, or throughout, a network for similar and even better bandwidth savings.

In some examples, transcoding options for edge nodes 104 and 114a-n may be optimized, towards clients 106 and 116a-n, respectively, for example according to a subset of a bitrate ladder according to requests from clients 106 and 116a-n. Other variations may include, but are not limited to, (i) one or more of edge nodes 104 and 114a-n may transcode to a different bitrate ladder depending on client context (e.g., for one or more of clients 106 and 116a-n), (ii) a scheme may be integrated with caching strategies on one or more of edge nodes 104 and 114a-n, (iii) real-time encoding may be implemented on one or more of edge nodes 104 and 114a-n depending on client context (e.g., for one or more of clients 106 and 116a-n), and combinations of (i)-(iii). Additionally, the encoding metadata (e.g., generated by servers 102 and/or 112) may be compressed to reduce overhead, for example, with the same coding tools as used when encoded as part of the video.

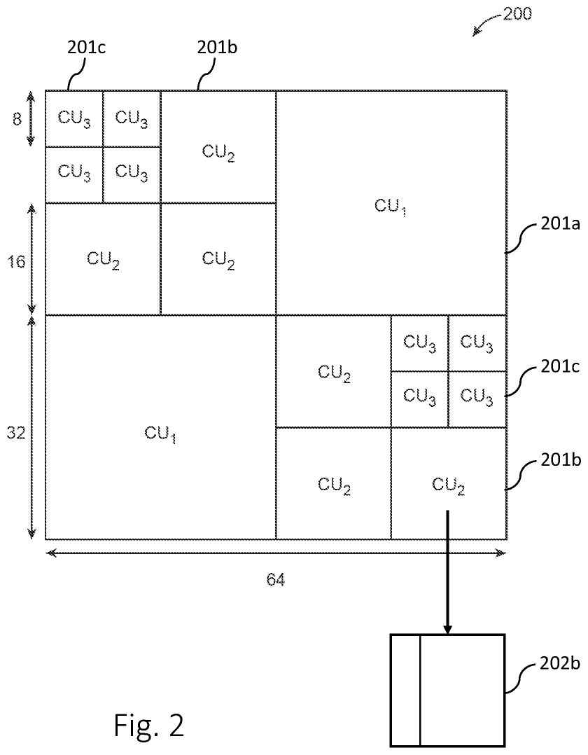

FIG. 2 is a diagram of an exemplary coding tree unit partitioning structure, in accordance with one or more embodiments. In transcoding representations from a highest quality representation, a coding unit partitioning structure (e.g., structure 200) of a coding tree unit (CTU) can be generated for an encoded frame (e.g., HEVC encoded) and saved as metadata. Partitioning structure 200 may be sent to an edge node or server (e.g., edge nodes 104 and 114a-n, edge servers X1-X3) as metadata. In some examples, a CTU may be recursively divided into coding units (CUs) 201a-c. For example, CTU partitioning structure 200 may include CUs 201a of a larger size, which may be divided into smaller size CUs 201b, which in turn may be divided into even smaller CUs 201c. In some examples, each division may increase a depth of a CU. In some examples, each CU may have one or more Prediction Units (PUs) (e.g., CU 201b may be further split into PUs 202b). In an HEVC encoder, finding the optimal CU depth structure for a CTU may be achieved using a brute force approach to find a structure with the least rate distortion (RD) cost. One of ordinary skill will understand that the CUs shown in FIG. 2 are exemplary, and do not show a full partitioning of a CTU, which may be partitioned differently (e.g., with additional CUs).

Partitioning structure 200 may be an example of an optimal partitioning structure (e.g., determined through an exhaustive search using a brute-force method as used by a reference software). An origin server (e.g., servers 102 and 112) may calculate a plurality of RD costs to generate optimal partitioning structure 200, which may be encoded and sent as metadata to an edge node (e.g., edge nodes 104 and 114a-n, edge servers X1-X3). An edge node may extract an optimal partitioning structure for a CTU (e.g., structure 200) from the metadata provided by an origin server and use it to avoid requiring a brute force search process (e.g., searching unnecessary partitioning structures). An origin server also may further calculate and extract prediction unit (PU) modes (i.e., an optimal PU partitioning mode may be the PU structure with the minimum cost), motion vectors, selected reference frames, and other data relating to a video input, to be included in the metadata to reduce burden on edge calculations. An origin server may be configured to determine which of n representations may be sent to an edge node (e.g., highest bitrate/resolution, intermediate or lower) for transcoding.

Example Methods

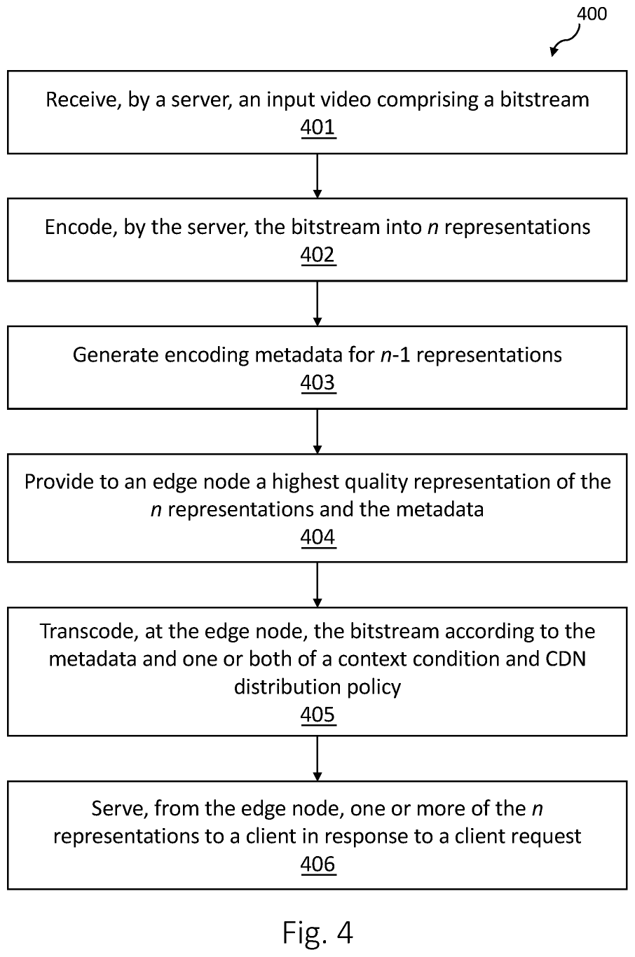

FIG. 4 is a flow diagram illustrating a method for lightweight transcoding at edge nodes, in accordance with one or more embodiments. Method 400 begins with receiving, by a server, an input video comprising a bitstream at step 401. The bitstream may be encoded into n representations by the server at step 402, for example, using High Efficiency Video Coding (HEVC) reference software (e.g., HEVC test model (HM) with random access and low delay configurations to satisfy both live and on-demand scenarios, VVC, AV1, ×265 (i.e., open source implementation of HEVC) with a variety of presets, and/or other codecs/configurations). During encoding, the server may be configured to generate (i.e., collect) metadata to be used for transcoding at an edge node, including generating encoding metadata for n−1 representations at step 403. The metadata may comprise information of varying complexity and granularity (e.g., CTU depth decision, motion vector information, PU, etc.). Time and complexity in transcoding at an edge node can be significantly reduced with this metadata (e.g., information of differing granularity collected at the origin server can enable tradeoffs in terms of bandwidth savings and reduce time-complexity at an edge node). In some examples, the encoding metadata may also be compressed to further reduce metadata overhead.

At step 404, a highest quality representation (e.g., highest bitrate, such as 4K or 8K) of the n representations and the metadata may be provided to (i.e., fetched by) an edge node (e.g., edge nodes 104 and 114a-n, edge servers X1-X3). In some examples, an edge node may employ an optimization model to determine whether a segment should be fetched with only the highest quality representation and metadata generated during encoding (i.e., corresponding to n−1 representations). In other examples, said optimization model may indicate that a segment should be downloaded from an origin server in more than one, or all, bitrate versions (e.g., more than one or all of n representations). For example, the optimization model may consider the popularity of a video or video segment in determining whether to fetch more than one, or all, of the n representations for said video or video segment. Since a small percentage of video content that is available is requested frequently, and often, for any requested video, only a portion of the video is viewed often (e.g., a beginning portion or a popular highlight), the majority of video segments may be fetched with one representation and the metadata, saving bandwidth and storage.

In some examples, the optimization model may consider aspects of a client request received from one or more clients (e.g., clients 106 and 116a-n). At the edge, the bitstream may be transcoded according to the metadata and one or both of a context condition and content delivery network (CDN) distribution policy at step 405. In some examples, transcoding may be performed in real time in response to the client request. In some examples, the CDN distribution policy may include a caching policy for both live and on-demand streaming, and other DVR-based functions. In other examples, no caching is performed. In some examples, the edge node may transcode the bitstream into the n−1 representations using the highest quality representation and the metadata. One or more of the n representations may be served (i.e., delivered) from the edge node to a client in response to a client request at step 406.

In some examples, an optimization model may indicate an optimal boundary point between a first set of segments that should be stored at a highest quality representation (i.e., highest bitrate) and a second set of segments that should be kept at a plurality of representations (i.e., plurality of bitrates). The optimal boundary point may be selected based on a request rate (R) during a time slot and as a function of a popularity distribution applied over an array (X) of video segments (ρ), such that a total cost of transcoding (i.e., computational overhead, including time) and storage is minimized. For any integer value x (1≤x≤ρ) as the candidate optimal boundary point, a storage cost may be:

Costₛₜ(x)=(x×h+(ρ−x)×f)×δ [Eq. 1]

where h denotes a size of the one or more segments stored at a highest bitrate plus the metadata for the one or more segments, f denotes a size of the one or more segments stored in all representations, and δ denotes a cost of storage in each time slot T with duration of 0 seconds. Thus, for any integer value x (1≤x≤ρ), the transcoding cost may be:

Costₜᵣ(x)=P(x)×R×β [Eq. 2]

where R denotes a number of arrived requests at the server in each time slot T and β denotes a computation cost for transcoding. Thus, the optimal boundary point (BP) for the given request arrival rate R and cumulative popularity function P(x) can be obtained by:

$$BP = {arg min}_{0 \leq x \leq ρ} \{ Co s {t}_{st} ( x ) + C o s {t}_{tr} ( x ) \} \qquad [ Eq . 3 ]$$

An optimal boundary point may be determined by differentiating a total cost function (Costₛₜ(x)+Costₜᵣ(x)) with respect to x and equaling to zero. In some examples, a heuristic algorithm may be used to evaluate candidates (e.g., a last segment) for optimal boundary points (bestX). An example heuristic algorithm may comprise:

| | |
|---|---|
| 1: | bestX ← ρ |
| 2: | lastVisited ← 1 |
| 3: | cost[bestX] ← CostFunc(bestX) |
| 4: | cost[bestX − 1] ← CostFunc(bestX−1) |
| 5: | cost[bestX + 1] ← ∞ |
| 6: | while true do |
| 7: | step ← abs(bestX − lastVisited) |
| 8: | temp ← bestX |
| 9: | if cost[bestX − 1] ≤ cost[bestX] then |
| 10: | bestX ← bestX − [step/2] |
| 11: | else if cost[bestX + 1 < cost[bestX] then |
| 12: | bestX ← bestX + [step/2] |
| 13: | else |
| 14: | break |
| 15: | end if |
| 16: | if bestX > ρ or best X ≤ 1 or bestX == lastVisited then |
| 17: | break |
| 18: | end if |
| 19: | lastVisited ← temp |
| 20: | cost[bestX] ← CostFunc(bestX) |
| 21: | cost[bestX − 1] ← CostFunc(bestX−1) |
| 22: | cost[bestX + 1] ← CostFunc(bestX+1) |
| 23: | end while |
| 24: | return bestX |

In lines 1-5, the heuristic algorithm considers the last segment as a candidate for (bestX) and calls CostFunc function to calculate Costₛₜ+Costₜᵣ for bestX and its adjacent segments. In the while loop (lines 7-12), the step and direction of the search process in the next iteration are determined. In case the cost of bestX is less than its adjacent segments (line 13) or the conditions in the if statement in line 16 are satisfied, the search process is finished and bestX is returned as the optimal boundary point (lines 13-23).

In an alternative embodiment, an intermediate quality representation (e.g., intermediate bitrate, such as 1080p or 4K) of the n representations may be provided (i.e., fetched) with the metadata, instead of a highest quality representation, at step 404. Upscaling may then be performed at the edge or the client (e.g., with or without usage of super-resolution techniques taking into account encoding metadata). In yet another alternative embodiment, all of the n representations are provided for a subset of segments (e.g., segments of a popular video, most played segments of a video, the beginning segment of each video) along with one representation (e.g., highest quality, intermediate quality, or other) and the metadata for other segments to enable lightweight transcoding at an edge node.

Advantages of the invention described herein include: (1) significant reduction of CDN traffic between (origin) server and edge node, as only one representation and encoding metadata is delivered instead of representations corresponding to the full bitrate ladder; (2) significant reduction of transcoding time and other transcoding costs at the edge due to the available encoding metadata, which offloads some or all complex encoding decisions to the server (i.e., origin server); (3) storage reduction at the edge due to maintaining metadata, rather than representations for a full bitrate ladder, at the edge (i.e., on-the-fly transcoding at the edge in response to client requests), which may result in better cache utilization and also better Quality of Experience (QoE) towards the end user eliminating quality oscillations.

In other examples, existing, optimized multi-rate/-resolution techniques may be used with this technique to reduce encoding efforts on the server (i.e., origin server). An edge node also may transcode to a different set of representations than the n representations encoded at an origin server (e.g., according to a different bitrate ladder), depending on needs and/or requirements from a client request, or other external requirements and configurations. In still other examples, representations and metadata may be transported from an origin server to an edge node within the CDN using different transport options (e.g., multicast-ABR, WebRTC-based transport), for example, to improve latency.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A distributed computing system for lightweight transcoding comprising:
an origin server comprising:
a first memory, and
a first processor configured to execute instructions stored in the first memory to:
receive an input video comprising a bitstream,
encode the bitstream into n representations, and
generate encoding metadata for n−1 representations; and
an edge node comprising:
a second memory, and
a second processor configured to execute instructions stored in the second memory to:
fetch a representation of the n representations and the encoding metadata from the origin server,
transcode the bitstream, and
serve one of the n representations to a client.

2. The system of claim 1, wherein the n representations correspond to a full bitrate ladder.

3. The system of claim 1, wherein the first processor is further configured to execute instructions stored in the first memory to compress the encoding metadata.

4. The system of claim 1, wherein the encoding metadata comprises a partitioning structure of a coding tree unit.

5. The system of claim 1, wherein the encoding metadata results from an encoding of the bitstream.

6. The system of claim 1, wherein the representation corresponds to a highest bitrate, and the encoding metadata corresponds to other bitrates.

7. The system of claim 1, wherein the second processor is configured to transcode the bitstream using a transcoding system.

8. The system of claim 7, wherein the transcoding system comprises a decoding module and an encoding module.

9. A method for lightweight transcoding, the method comprising:
receiving, by a server, an input video comprising a bitstream;
encoding, by the server, the bitstream into n representations;
generating metadata for n−1 representations; and
providing to an edge node a representation of the n representations and the metadata,
wherein the edge node is configured to transcode the bitstream into the n−1 representations using the metadata.

10. The method of claim 9, wherein the n representations correspond to a full bitrate ladder.

11. The method of claim 9, wherein the representation comprises a highest quality representation corresponding to a highest bitrate.

12. The method of claim 9, wherein the representation comprises an intermediate quality representation corresponding to an intermediate bitrate.

13. The method of claim 9, wherein generating the metadata comprises storing an optimal search result from the encoding as part of the metadata.

14. The method of claim 9, wherein generating the metadata comprises storing an optimal decision from the encoding as part of the metadata.

15. The method of claim 9, further comprising compressing the metadata.

16. The method of claim 9, wherein the representation comprises a subset of the n representations.

17. A method for lightweight transcoding, the method comprising:
fetching, by an edge node from an origin server, a representation of a video segment and metadata associated with a plurality of representations of the video segment, the origin server configured to encode a bitstream into the plurality of representations and to generate the metadata;
transcoding the bitstream into the plurality of representations using the representation and the metadata; and
serving one or more of the plurality of representations to a client in response to a client request.

18. The method of claim 17, further comprising determining, according to an optimization model, whether the representation of the video segment should comprise one of the plurality of representations or all of the plurality of representations.

19. The method of claim 18, wherein the optimization model comprises an optimal boundary point between a first set of segments for which one of the plurality of representations should be fetched and a second set of segments for which all of the plurality of representations should be fetched, the determining based on whether the video segment is in the first set of segments or the second set of segments.

20. The method of claim 19, further comprising determining the optimal boundary point using a heuristic algorithm.
